(19) United States
(12) Patent Application Publication
(10) Pub. No.: US 2021/0373919 A1
(43) Pub. Date: Dec. 2, 2021

(54) DYNAMIC USER INTERFACE

(71) Applicant: Alarm.com Incorporated, Tysons, VA (US)

(72) Inventors: Rebecca Elisabeth Davenport, Falls Church, VA (US); Anthony Francisco Collurafici, Freeland, MD (US); Stephen Scott Trundle, Falls Church, VA (US); Daniel Todd Kerzner, McLean, VA (US)

(21) Appl. No.: 17/325,630

(22) Filed: May 20, 2021

Related U.S. Application Data
(60) Provisional application No. 63/029,829, filed on May 26, 2020.

(51) Int. Cl. G06F 9/451; G06F 3/0482; H04L 29/08; H04W 4/80; H04W 4/38

(52) U.S. Cl. CPC G06F 9/451; G06F 3/0482; H04L 67/18; H04W 84/12; H04W 4/80; H04W 4/38; H04L 67/306

(57) ABSTRACT

Methods, systems, and apparatus, including computer programs encoded on computer storage media, for generating a user interface dynamically. One of the methods includes detecting sensors that are installed at a physical location associated with a user account; determining data for the user account associated with a user device; selecting, based on the sensors that are installed at the physical location and the data for the user account associated with the user device, a graphical user interface component to show in a user interface on a display of the user device from a set of graphical user interface components; and providing the graphical user interface component to show in the user interface on the display of the user device.

### CROSS-REFERENCE TO RELATED APPLICATIONS

This application claims the benefit of U.S. Provisional Application No. 63/029,829, filed May 26, 2020, and titled “DYNAMIC USER INTERFACE,” which is incorporated by reference in its entirety.

### BACKGROUND

Some people participate in network activities each day. For instance, a person may post an article online, write an electronic note to a friend, update firewall settings for their computer, or interact with a home security system. In some instances, a person may access a native application or a web application to interact with their home security system. The application can provide functionality for the home security system. For example, the application can present a video stream of data captured by a camera that is part of the home security system.

### SUMMARY

To reduce an amount of time necessary to generate a user interface, e.g., by reducing an amount of menu options to generate and present in a user interface, present content more efficiently, summarize menu options, enable users to more efficiently interact with a security system, or a combination of two or more of these, compared to prior systems, a system can dynamically configure a user interface for a device using data about sensors at a physical location, interaction data for multiple different users, settings data for multiple different users, or a combination of two or more of these. For instance, the system can summarize menu options by generating menu options that perform multiple actions rather than having only separate menu options for each of the multiple actions. In some examples, the systems and methods described in this document can present more relevant content and to enable users to more efficiently interact with a security system, compared to prior systems.

The physical location can be a home, a room in a home, an office, or another appropriate physical location. For instance, the device and the sensors can be in the same house or in the same room. The sensors can include property monitoring sensors, such as a camera, a motion sensor, or a microphone, that are installed at the physical location, e.g., part of a security system for the physical location.

In general, one aspect of the subject matter described in this specification can be embodied in methods that include the actions of detecting sensors that are installed at a physical location associated with a user account; determining data for the user account associated with a user device; selecting, based on the sensors that are installed at the physical location and the data for the user account associated with the user device, a graphical user interface component to show in a user interface on a display of the user device from a set of graphical user interface components; and providing the graphical user interface component to show in the user interface on the display of the user device.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Determining the data for the user account associated with the user device can include determining a physical location of the user device. Selecting the graphical user interface component can include selecting, based on the sensors that are installed at the physical location and the data for the user account, the graphical user interface component to show on the display of the user device from a set of graphical user interface components in response to determining the physical location of the user device.

In some implementations, determining the data for the user account associated with the user device can include determining that the user device is physically located near the physical location at which the sensors are installed. Selecting the graphical user interface component can include selecting, based on the sensors that are installed at the physical location and the data for the user account, the graphical user interface component to show on the display of the user device from a set of graphical user interface components in response to determining that the user device is physically located near the physical location.

In some implementations, determining that the user device is physically located near the physical location at which the sensors are installed can include receiving, from one of the sensors, sensor data that indicates that the user device is physically located near the physical location at which the sensors are installed. Receiving the sensor data that indicates that the user device is physically located near the physical location at which the sensors are installed can include monitoring the user device relative to one or more known sensor locations. The one or more known sensor locations can be fixed locations. Each of the one or more known sensor locations can correspond to a physical location of at least one of the sensors.

In some implementations, detecting the sensors that are installed at the physical location associated with the user account can include determining a particular sensor from the sensors that is physically closest to the user device. Selecting the graphical user interface component can include selecting, based on the particular sensor that is physically closest to the user device and the data for the user account, the graphical user interface component to show on the display of the user device from a set of graphical user interface components in response to determining the physical location of the user device.

In some implementations, the method can include receiving near field communication data that indicates that at least one of the sensors created a near field communication connection with the user device. Determining that the user device is physically located near the physical location at which the sensors are installed can include determining, using the near field communication data, that the user device is physically located near the physical location at which the sensors are installed. Receiving the near field communication data can include receiving the near field communication data that indicates that at least one of the sensors created a wireless connection with the user device.

In some implementations, the physical location can include at least a portion of a property. The at least the portion of the property can be a room on the property. The at least the portion of the property can be a building on the property. The sensors can be part of a home monitoring system associated with the user account.

In some implementations, determining the data for the user account associated with the user device can include determining historical use data that indicates input received by the user interface for the user account. Selecting the graphical user interface component can include selecting, based on data for the sensors that are installed at the physical location and the historical use data that indicates the input received by the user interface for the user account, the graphical user interface component to show on the display of the user device from a set of graphical user interface components. The historical use data can include data for two or more other user accounts different from the user account associated with the user device.

In some implementations, the account for the user device can be associated with a user interface type from a group of multiple, different user interface types each of which is associated with a subset of the accounts from the two or more other user accounts. The historical data can include data for the user accounts in the two or more other user accounts that are associated with the user interface type. Selecting the graphical user interface component can include selecting, based on data for the sensors that are installed at the physical location and the historical use data for the user accounts that are associated with the user interface type, the graphical user interface component to show on the display of the user device from a set of graphical user interface components.

In some implementations, determining the data for the user account associated with the user device can include determining, using the data for the user account, demographic data for people who live in a house with a user of the user device. Selecting the graphical user interface component can include selecting, based on data for the sensors that are installed at the physical location and the demographic data for the people who live in the house with the user of the user device, the graphical user interface component to show on the display of the user device from a set of graphical user interface components.

In some implementations, the method can include determining, for a sensor from the detected sensors, user interface configuration parameters a) defined by a third party, and b) that indicate a weight for at least one graphical user interface component from the set of graphical user interface components. Selecting the graphical user interface component can include selecting the graphical user interface component to show on the display of the user device from a set of graphical user interface components using data for the sensors that are installed at the physical location, the data for the user account, and the user interface configuration parameters that indicate the weight for at least one graphical user interface component from the set of graphical user interface components. The third party can be one of a manufacturer the sensor, an installer of the sensor, and a home security provider that offers services based on data from the sensor.

In some implementations, the method can include detecting second sensors a) that are installed at the physical location associated with the user account, and b) are different sensors from the sensors; selecting, from the set of graphical user interface components and based on the second sensors that are installed at the physical location and the data for the user account associated with the user device, a second graphical user interface component to show in the user interface on the display of the user device, the second graphical user interface component being a different user interface component from the graphical user interface component; and providing the second graphical component to show in the user interface on the display of the user device.

In some implementations, the method can include detecting third sensors a) that are installed at another physical location associated with the user account, and b) are different sensors from the sensors and the second sensors; selecting, from the set of graphical user interface components and based on the third sensors that are installed at the physical location and the data for the user account associated with the user device, the second graphical user interface component to show in the user interface on the display of the user device. The second graphical user interface component can be a default graphical user interface component for the user account. The method can include providing the second graphical component to show in the user interface on the display of the user device. The physical location and the other physical location can be the same physical location.

The subject matter described in this specification can be implemented in various embodiments and may result in one or more of the following advantages. In some implementations, a system or method that dynamically configures a user interface using data about sensors installed at a physical location, e.g., associated with a user account, can reduce an amount of time necessary to generate a user interface, present content more efficiently, summarize menu options, e.g., rather than or in addition to presenting multiple menu options, or a combination of two or more of these.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment with a dynamic user-interface configuration system.

FIGS. 2A-C depict example user interfaces.

FIG. 3 is a flow diagram of a process for providing a graphical user interface component.

FIG. 4 is a diagram illustrating an example of a home monitoring system.

Like reference numbers and designations in the various drawings indicate like elements.

### DETAILED DESCRIPTION

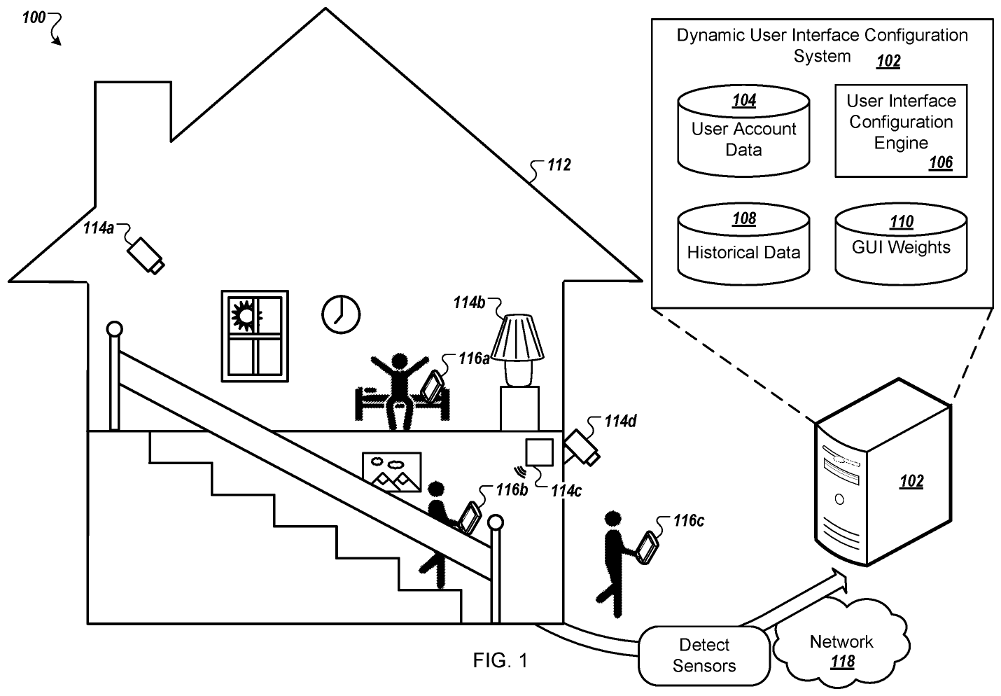

FIG. 1 depicts an example environment 100 with a dynamic user-interface configuration system 102. The dynamic user-interface configuration system 102 analyzes data from various sources and generates configuration instructions for presentation of a user interface based on the data. The configuration of the user interface can be based on a physical location, such as a house 112. This can enable the dynamic user-interface configuration system 102 to configure a user interface differently depending on whether the data indicates that a user device, that will present the user interface, is physically located at a user's house 112, office, or another location. When the dynamic user-interface configuration system 102 configures the user interface differently for different physical locations, the dynamic user-interface configuration system 102 can optimize presentation of the user interface differently for different physical locations, reduce an amount of content the dynamic user-interface configuration system 102 sends to the user device, or both.

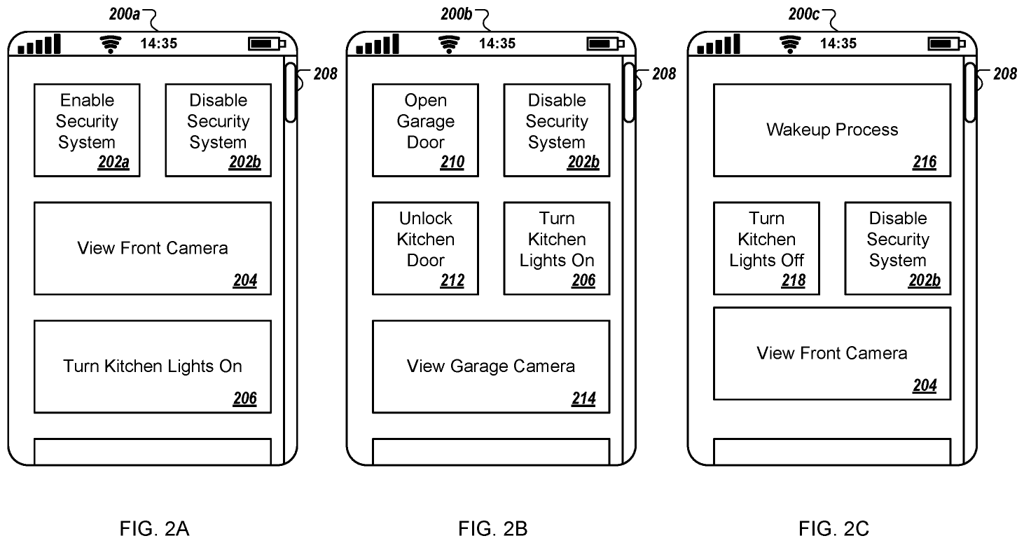

For instance, the dynamic user-interface configuration system 102 can use data from one or more sensors 114a-d installed at the house 112 to determine a physical location within the house at which the user device 116a-c is located. When the dynamic user-interface configuration system 102 determines that the user device 116a is in a bedroom, using data received from a camera 114a and a lamp 114b, the dynamic user-interface configuration system 102 can configure a user interface with a first set of graphical user interface components, such as the components discussed with reference to FIGS. 2A-C.

The dynamic user-interface configuration system 102 selects the first set of graphical user interface components using user account data 104. The user account data 104 can include data that indicates a physical location of the user device 116a, an estimated physical location of the user device 116a, e.g., when the user device 116c is not in the house 112, data about one or more people who live in the house, e.g., demographic data, historical data 108, or a combination of two or more of these. For instance, the dynamic user-interface configuration system 102 can determine the physical location of the user device 116a based on data from the camera 114a and the lamp 114b and generate configuration instructions for a user interface that components for a wakeup process. The components for the wakeup process can include a component to turn the lamp 114b on, a component to monitor a front camera 114d, e.g., to see if the newspaper was already delivered, and other appropriate components for the wakeup process.

The dynamic user-interface configuration system 102 can determine, e.g., using a user-interface configuration engine 106, the components using the historical data. The dynamic user-interface configuration system 102 can receive data, e.g., from a computer at the house 112 or from the user device 116a, that indicates the input received by the user interface. The dynamic user-interface configuration system 102 can store the received data in a database, e.g., the historical data 108.

The user-interface configuration engine 106 can use data from the historical data 108 to determine typical patterns of interaction with the user interface. The user-interface configuration engine 106 can use data about these patterns to configure the user interface to present certain components more prominently during times or when the user device 116a-c is at a physical location, or both, at which those certain components satisfy a threshold likelihood of being selected.

The user-interface configuration engine 106 can configure components that do not satisfy the threshold likelihood of being selected for presentation less proximately than the components that satisfy the threshold likelihood. For instance, the user-interface configuration engine 106 can configuration the user interface to not include one or more components that do not satisfy the threshold likelihood of being selected. This can reduce an amount of time necessary for the user device 116a-c to render the user interface, an amount of bandwidth the dynamic user-interface configuration system 102 uses to send user interface data, e.g., instructions, to the user device 116a-c, or both.

As the user device 116a-c moves, the dynamic user-interface configuration system 102 can receive data about other sensors that are physically near the location of the user device 116a-c. For example, when the user device 116b is on a staircase, the dynamic user-interface configuration system 102 can receive data from a motion sensor 114c that indicates that the user device 116a-c is near the motion sensor 114c.

The dynamic user-interface configuration system 102 can use data from the sensors 114a-d to detect a sensor that is physically closest to the user device 116a-c. The dynamic user-interface configuration system 102 can change the configuration for the user interface based on the physically closest sensor. For instance, when the dynamic user-interface configuration system 102 determines that the user device 116b is in the staircase, the user-interface configuration engine 106 can configure the user interface with components to turn on or off lights around the staircase, to disable a security alarm, e.g., when the staircase is near the front door of the house 112, or to present menu options for a kitchen.

In some examples, the user-interface configuration engine 106 can configure the user interface differently at different times of day upon receipt of the same sensor data. For example, the user-interface configuration engine 106 can configure the user interface to include a component to disable the security alarm when the user device 116b is on the staircase at 8AM and can configure the user interface to include one or more components for kitchen menu options when the user device 116b is on the staircase at 7 PM.

The dynamic user-interface configuration system 102 can detect sensors near the user device 116a-c using any appropriate method. For example, the dynamic user-interface configuration system 102 can receive data from one or more of the sensors 114a-d. The data can indicate that the sensors are in communication with the user device 116a-c, e.g., using near field communication. The data can depict one or more images of the user device 116a-c, e.g., when received from the camera 114a. The dynamic user-interface configuration system 102, or another system, can analyze the images or some of the images to determine whether the images depict the user device 116a-c.

In some implementations, the dynamic user-interface configuration system 102 can determine to configure the user interface with default settings. For instance, when the dynamic user-interface configuration system 102 determines that no sensors are within a threshold distance from the user device 116a-c, that the user device 116c is located outside a particular physical location, e.g., the house 112, or in other appropriate situations, the dynamic user-interface configuration system 102 can determine to use a default configuration for the user interface. This can enable presentation of all menu options, presentation of general menu options more prominently than specialized menu options, or both, when the user interface does not likely need to be optimized.

The dynamic user-interface configuration system 102 can configure the user interface using a database of graphical user interface components, a database of user interface layouts, or both. For instance, the dynamic user-interface configuration system 102 can access a database of components associated with historical use data, e.g., in the historical database 108, other devices, e.g., sensors 114a-d, or both. The dynamic user-interface configuration system 102 can determine, using the historical data 108, the components that have the highest likelihood of being selected. The historical data 108 can include received sensor data, data that indicates selection of components in the user interface, time of day of sensor data capture, time of day of component selection, or a combination of two or more of these. The dynamic user-interface configuration system 102 can configure the user interface using data that indicates that certain components enable interaction with corresponding sensors. For example, the user-interface configuration engine 106 can configure the user interface with certain components associated with sensors that were detected near the user device 116a-c while skipping configuration of the user interface with other components that are associated with other sensors that were not detected near the user device 116a-c.

In some examples, the dynamic user-interface configuration system 102 can determine, using the historical data 108, a user interface layout from multiple user interface layouts that will most prominently present the graphical user interface components that have the highest likelihood of being selected. The dynamic user-interface configuration system 102 can select a user interface layout from multiple user interface layouts using data that identifies sensors physically near to the user device 116a-c. For instance, when the dynamic user-interface configuration system 102 detects that the user device 116a is in a bedroom, the dynamic user-interface configuration system 102 can select a first user interface layout, with components that enable interaction with network connected devices in the bedroom, while the dynamic user-interface configuration system 102 can select a second user interface layout when it detects that the user device 116c is in the front yard of the house 112.

In some implementations, the dynamic user-interface configuration system 102 can associate weights 110 to the graphical user interface components, the user interface layouts, or both. The weights 110 can associate the graphical user interface components with times of day, days of the week, specific sensors, sensor types, or some combination of two or more of these. For instance, when the dynamic user-interface configuration system 102 determines that a first component is selected most frequently at 8 AM, it can assign a weight 110 to the first component that indicates that increase a likelihood that the user-interface configuration engine 106 configures the user interface with the first component when it is around 8 AM.

In some examples, the weights 110 can be defined by one or more sensor parameters. For instance, the camera 114a can include multiple configuration parameters. The configuration parameters can indicate how the dynamic user-interface configuration system 102 can communicate with the camera 114a, settings for the camera 114a, and other options.

In some implementations, each user account can be associated with one of the multiple user interface layouts. In these implementations, the dynamic user-interface configuration system 102 can select the graphical user interface component using historical use data for the user accounts that are associated with the same user interface type as the account for the user device 116a-c.

The configuration parameters can include one or more weights 110 that associate the sensor with one or more respective graphical user interface components. The configuration parameters can include one weight for each graphical user interface component. The configuration parameters can include fewer weights than the number of graphical user interface components. For instance, the dynamic user-interface configuration system 102 can store a vector of weight values for the sensor. The vector can include one value for each of the graphical user interface components, or one value for the graphical user interface components that enable control of the senor, e.g., so that the vector does not have values of zero for the unrelated graphical user interface components.

In some implementations, the dynamic user-interface configuration system 102 can configure the user interface using data for the people who live in the house 112. For instance, the dynamic user-interface configuration system 102 can use demographic data for the people who live in the house 112 when configuring the user interface. When the dynamic user-interface configuration system 102 detects that a user of the user device 116a-c is likely below a threshold age, e.g., a child, the dynamic user-interface configuration system 102 can determine to not cause presentation of the user interface on the user device 116a-c, to configure the user interface with child friendly options, e.g., options to turn lights on or off or both, or take some other appropriate action.

In some examples, when the dynamic user-interface configuration system 102 determines that the user device 116a-c is at the house 112 and that a child lives or is currently at the house 112, the dynamic user-interface configuration system 102 can determine whether the user device 116a-c is being operated by the child. If the dynamic user-interface configuration system 102 determines that the device is being operated by the child, the dynamic user-interface configuration system 102 can cause presentation of the child friendly mode. If the dynamic user-interface configuration system 102 determines that the device is not being operated by a child, the dynamic user-interface configuration system 102 can determine to not present the child friendly mode and to present the user interface, e.g., based on the sensor data.

In some implementations, the dynamic user-interface configuration system 102 can configure the user interface using contextual information. For instance, the dynamic user-interface configuration system 102 can use data from the sensors 114a-d, or other data associated with a user account for the physical location, e.g., the house 112, to configure the user interface. In some examples, when the user-interface configuration engine 106 receives a specific set of input, the user-interface configuration engine 106 configures the user interface to include a particular component, e.g., at the top of the user interface or otherwise prominently. But when the user-interface configuration engine 106 receives, along with the specific set of input, data that an alarm at the house 112 is going off, the user-interface configuration engine 106 can configure the user interface to not include the particular component, or to present the particular component less prominently than if the alarm was not going off.

In some implementations, when the user-interface configuration engine 106 can configure the user interface to automatically present a live video stream. When the dynamic user-interface configuration system 102 determines that the user device 116a-c is using a virtual private network (“VPN”) connection, the dynamic user-interface configuration system 102 can determine to skip providing the video stream to the user device 116a-c over a public network, e.g., the Internet. The dynamic user-interface configuration system 102 can determine whether the user device 116a is co-located with a camera, e.g., the camera 114a, that is generating the video stream that can be presented automatically in the user interface.

Upon determining that the user device 116a is co-located with the camera, the dynamic user-interface configuration system 102 can enable a direct connection between the user device 116a and the camera, e.g., using a wireless network such as a Bluetooth or a WiFi network, for presentation of the video stream in the user interface. For example, the Upon determining that the user device 116a is co-located with the camera, the dynamic user-interface configuration system 102 can send instructions to the user device 116a that cause presentation of the user interface, creation of a connection with the camera, and presentation of the live stream in the user interface. Upon determining that the user device 116a is not co-located with the camera, the dynamic user-interface configuration system 102 can determine to skip presentation of the live stream and to configure the user interface with other content instead.

In some implementations, the dynamic user-interface configuration system 102 can determine a technology with which to provide live stream data based on whether the user device 116a is co-located with the camera. For instance, when the dynamic user-interface configuration system 102 determines that the user device 116a is co-located with the camera, the dynamic user-interface configuration system 102 can provide the live stream to the user device 116a using a first technology, e.g., a wireless connection. Upon determining that the user device 116a is not co-located with the camera, the dynamic user-interface configuration system 102 can provide the live stream to the user device 116a using a second, different technology, e.g., a cellular connection with a reduced resolution live stream.

In some implementations, the dynamic user-interface configuration system 102 can determine whether to initiate a duress mode for the user interface. The dynamic user-interface configuration system 102 can use data from one of the sensors 114a-d, e.g., a camera, to detect that another person is at the physical location, e.g., the house 112, and to configure the user interface in a duress mode. In some examples, the dynamic user-interface configuration system 102 can use data from the user device 116a-c, e.g., a pre-configured duress code or password, to determine to configure the user interface in a duress mode.

When configured in the duress mode, the user interface can include fewer components than normal. For instance, when the dynamic user-interface configuration system 102 might normally configure the user interface to include content from a video stream or a component that causes presentation of a video stream, the dynamic user-interface configuration system 102 would not include these options in the duress mode.

In some examples, the dynamic user-interface configuration system 102 can generate a duress mode user interface that does not change any settings, e.g., of a corresponding security system. The duress mode user interface can have components that would normally appear, based on the location or default user interface, but do not actually control the security system.

The dynamic user-interface configuration system 102 can be implemented at any appropriate location. For instance, the dynamic user-interface configuration system 102 can be part of the user device 116a-c. The dynamic user-interface configuration system 102 can be implemented in the cloud. In some examples, the dynamic user-interface configuration system 102 can be physically located at a particular physical location, e.g., a house or an office associated with a user account for the user device 116a-c.

The dynamic user-interface configuration system 102 is an example of a system implemented as computer programs on one or more computers in one or more locations, in which the systems, components, and techniques described in this document are implemented. The user device 116a-c may include personal computers, mobile communication devices, and other devices that can send and receive data over a network 118. The network, such as a local area network (LAN), wide area network (WAN), the Internet, or a combination thereof, connects the user device 116a-c, and the dynamic user-interface configuration system 102. The dynamic user-interface configuration system 102may use a single server computer or multiple server computers operating in conjunction with one another, including, for example, a set of remote computers deployed as a cloud computing service.

The dynamic user-interface configuration system 102 can include several different functional components, including the user-interface configuration engine 106. The user-interface configuration engine 106 can be implemented as computer programs installed on one or more computers in one or more locations that are coupled to each through a network. In cloud-based systems for example, these components can be implemented by individual computing nodes of a distributed computing system.

FIGS. 2A-C depict example user interfaces 200a-c. The user interfaces can be part of a security system application or another appropriate application. The user interfaces can be presented by a native application, e.g., developed for a particular operating system, a web application, or both, e.g., when an application includes both native and web versions.

FIG. 2A depicts an example of a default user interface 200a for the application. The default user interface 200a includes two components 202a-b to enable and disable a security system, a camera component 204 to view a live video stream from a front camera, and a turn kitchen lights on component 206. The default user interface 200a can include other components that can be presented, and selected, by user interaction with a scroll bar 208a.

FIG. 2A depicts an example of a first customized user interface 200b for the application. The dynamic user-interface configuration system can configure the user interface 200b upon detecting that a user device is outside a physical location, e.g., a house. The dynamic user-interface configuration system can configure the user interface 200b upon determining that the house is locked. For instance, upon such a determination, the dynamic user-interface configuration system can configure the user interface 200b to include an open garage door component 210, a disable security system component 202b, an unlock kitchen door component 212, a turn kitchen lights on component 206, and a view garage camera component 214.

One or more of the components included in the first customized user interface 200b can be included in the default user interface 200a. The dynamic user-interface configuration system can change a position of one or more of the components, a size of one or more of the components, or both, based on the detected sensors, other various inputs described in this document, or both. For instance, the dynamic user-interface configuration system can determine that when a user device is detected outside the physical location, a security system for the physical location normally receives input that opens the garage door, disables the security system, and unlocks the kitchen door. The dynamic user-interface configuration system can configure the first customized user interface with these components because of the input normally received after the user device is outside the physical location.

The dynamic user-interface configuration system can include, in the first customized user interface 200b, other components related to the components selected based on the detected sensors. For instance, the dynamic user-interface configuration system can include the view garage camera component 214 in the first customized user interface 200b based on the configuration of the first customized user interface 200b with the open garage door component, the disable security system component 202b, or both.

The first customized user interface 200b can include the enable security system component 202a in a less prominent position than that of the default user interface 200a, or might not include the enable security system component 202a. For instance, when the dynamic user-interface configuration system determines that the user device is outside the physical location and the security system is already enabled, the dynamic user-interface configuration system can determine to customize the user interface to not include the enable security system component 202a.

In some implementations, the dynamic user-interface configuration system can customize the user interface for multiple different physical locations, e.g., properties. Some examples of different physical locations include a house, an office, and a vacation house. The dynamic user-interface configuration system can determine when the user device is near the different physical locations and configure the user interface accordingly. For instance, when the user device is within a mile of the vacation house but two-hundred miles from the house, the dynamic user-interface configuration system can configure the user interface to include options for the vacation house, e.g., with a heat hot tub component, rather than with components specific to the house, e.g., the turn kitchen lights on component 206.

FIG. 2C depicts an example of a second customized user interface 200c for the application that includes a macro. The dynamic user-interface configuration system can analyze historical data for the user device, e.g., historical input with the application, and detect sequences of actions that satisfy a threshold frequency, e.g., are performed at least a threshold number of times. The dynamic user-interface configuration system can determine a context within which the sequence of actions is performed. When the dynamic user-interface configuration system detects that context, e.g., based on data for the sensors, the dynamic user-interface configuration system can configure the user interface to include a component that automatically performs the sequence of actions.

For instance, the second customized user interface 200c includes a wakeup process component 216 and a turn kitchen lights off component 218. When the dynamic user-interface configuration system determines that the security system frequently performs, at 8AM each weekday, actions to turn on a side table light, begin playing music, and warm up the bathroom, the dynamic user-interface configuration system can create the wakeup process component 216 that will automatically perform these actions when the second customized user interface 200c receives data indicating user selection of the wakeup process component 216.

The dynamic user-interface configuration system can analyze the historical data and request, from the user device, input that confirms creation of a macro. The request can identify the actions that will be performed upon selection of a corresponding macro user-interface component, e.g., the wakeup process component 216. The request can identify the context in which the macro user-interface component will be presented, e.g., around 8 AM each weekday. This can enable receipt of user input that changes the sequence of actions, either the timing of the actions or the order in which the actions are performed, changes the context in which the macro user-interface component will be presented, or both.

In some implementations, the dynamic user-interface configuration system can configure the user interface to present a series of suggested components upon detection of a particular context. The series of suggested components can enable selection of any of the suggested components while not causing performance of actions associated with each of the suggested components. For instance, presentation of the series of suggested components can give a user flexibility to skip any individual components that might not be relevant in that particular instance.

In some implementations, the dynamic user-interface configuration system can configure the user interface as the second customized user interface 200c in different contexts. For instance, the dynamic user-interface configuration system can configure the user interface as the second customized user interface 200c when detecting first sensors and when detecting second sensors. The second sensors can be different from the first sensors. The first sensors can be for a first physical location, e.g., a first house. The second sensors can be for a second physical location, e.g., a second house such as a vacation house. In some examples, the different contexts are different combinations of sensors, different times of day, or both.

For the different contexts, the dynamic user-interface configuration system can configure selection of one or more of the components in the second customized user interface 200c to cause different actions, actions that interact with different devices, or both. For instance, when a user device receives data indicating selection of the wakeup process component 216 while in a first context, the user device can cause a bedroom lamp and a furnace at a first physical location to turn on, e.g., to increase the temperature. When a user device receives data indicating selection of the wakeup process component 216 while in a different, second context, the user device can cause an overhead light and blinds at a different, second physical location to turn on.

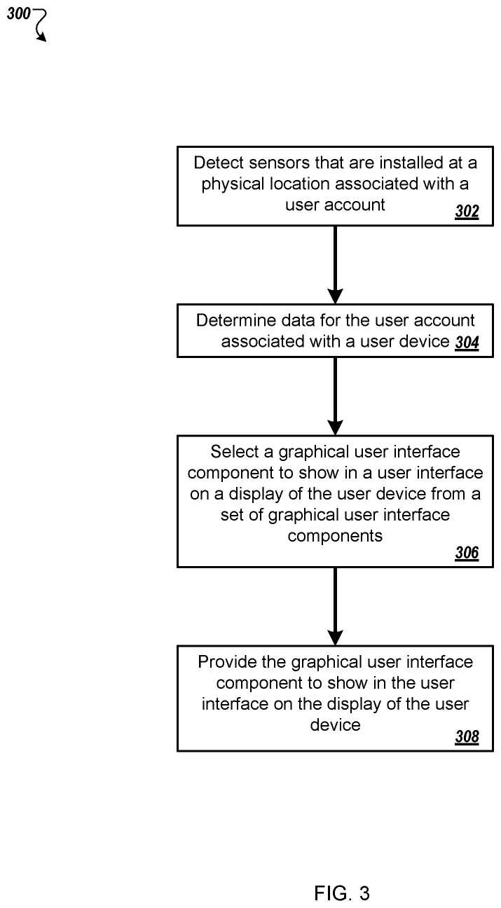

FIG. 3 is a flow diagram of a process 300 for providing a graphical user interface component. For example, the process 300 can be used by the dynamic user-interface configuration system 102 from the environment 100.

A dynamic user-interface configuration system detects sensors that are installed at a physical location associated with a user account (302). The physical location can be a house, an office, a vacation home, or another appropriate physical location.

In some implementations, the dynamic user-interface configuration system waits to detect the sensors until receiving data that indicates a request for presentation of a user interface. For instance, upon receipt of the data that indicates the request for presentation of the user interface, the dynamic user-interface configuration system can detect the sensors that are installed at the physical location associated with the user account. The request can identify the user account for which the user interface will be presented.

The dynamic user-interface configuration system determines data for the user account associated with a user device (304). The data for the user account can be data that identifies a user device for the user account, data that indicates a location or likely location for the user device, historical data for the user account, e.g., historical user-interface usage data, and other appropriate data.

The dynamic user-interface configuration system selects a graphical user interface component to show in a user interface on a display of the user device from a set of graphical user interface components (306). For instance, the dynamic user-interface configuration system can select the component based on the sensors that are installed at the physical location and the data for the user account. The dynamic user-interface configuration system can select the component using a recognized pattern of behavior for a user of the user device, a daily pattern of activity for the user of the user device, a pattern of usage for an application that includes the user interface, alarm data, weather data, a type of account, e.g., video-only, security only, power user, or any combination of two or more of these. Some examples of a pattern of usages for the application can include changing a thermostat setting every time the application is presented, or always play living room video after turning on living room light through the application.

In some implementations, selection of the graphical user interface component can cause a contextual action within the application. The contextual action can be based on the context of the sensors, the user device, or both.

In some implementations, the dynamic user-interface configuration component can cause the application to automatically start some action in response to the detection of the sensors, using data for the sensors, or both. The dynamic user-interface configuration component can cause the application to automatically start some action in response to the determination of the data for the account, using the data for the account, or both. One example of an automatic action includes automatically presenting a video stream when the user interface is displayed on a device, e.g., the user device.

The dynamic user-interface configuration system provides the graphical user interface component to show in the user interface on the display of the user device (308). For instance, the dynamic user-interface configuration system can provide the graphical user interface component to the user device.

In some implementations, the dynamic user-interface configuration system can provide the graphical user interface component to a device other than the user device. For example, the dynamic user-interface configuration system can provide the graphical user interface component to a desktop computer, or another computer, associated with the user account. This can enable the other computer to more easily adjust settings for a security system based on a location of the user device. When the other computer is operated by a parent, this can enable the parent to more easily adjust settings for a security system of a house in which a child is physically located.

The order of steps in the process 300 described above is illustrative only, and providing a graphical user interface component can be performed in different orders. For example, the dynamic user-interface configuration system can determine the data for the user account and then detect sensors that are installed at the physical location associated with the user account.

In some implementations, the process 300 can include additional steps, fewer steps, or some of the steps can be divided into multiple steps. For example, the dynamic user-interface configuration system can determine user-interface configuration parameters for one or more of the sensors. The dynamic user-interface configuration system can use the user-interface configuration parameters when selecting the graphical user interface component.

The user-interface configuration parameters can be defined by a third party, e.g., a party other than an entity that manages the dynamic user-interface configuration system, a user of the user device, or both. The third party can be a manufacturer a sensor, e.g., included in a home security system, an installer of the sensor, and a home security provider that offers services based on data from the sensor, or a combination of two or more of these.

For instance, an environment can include two or more third parties, including a first vendor and a second vendor. Either or both of the vendors can be home security providers. The system can receive, from a first computer associated with the first vendor, first user-interface configuration parameters that assign a higher weight to video graphical user interface components associated with presentation of video content, e.g., from a camera included in a home security system. The system can receive, from a second computer associated with the second vendor, second user-interface configuration parameters that assign a higher weight to audio graphical user interface components associated with presentation of audio content, e.g., from a camera or microphone, optionally associated with a doorbell, included in a home security system.

When the system determines that a particular context exists, e.g., using data from the sensors, the system accesses the user-interface configuration parameters to dynamically configure a user interface. When the system configures a user interface for a user device that connects to a security system maintained by the first vendor based on the particular context, the system configures the user interface with video graphical user interface components more prominently displayed based on the higher weights for those components. When the system configures a user interface for a user device that connects to a security system maintained by the second vendor based on the particular context, the system configures the user interface with audio graphical user interface components more prominently displayed based on the higher weights for those components. In this example, the system configures a user interface differently because of the different user-interface configuration parameters even though the system otherwise detected that the same particular context exists.

The user-interface configuration parameters can indicate a weight for at least one graphical user interface component from the set of graphical user interface components. The dynamic user-interface configuration system can use the weight when selecting the graphical user interface component.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

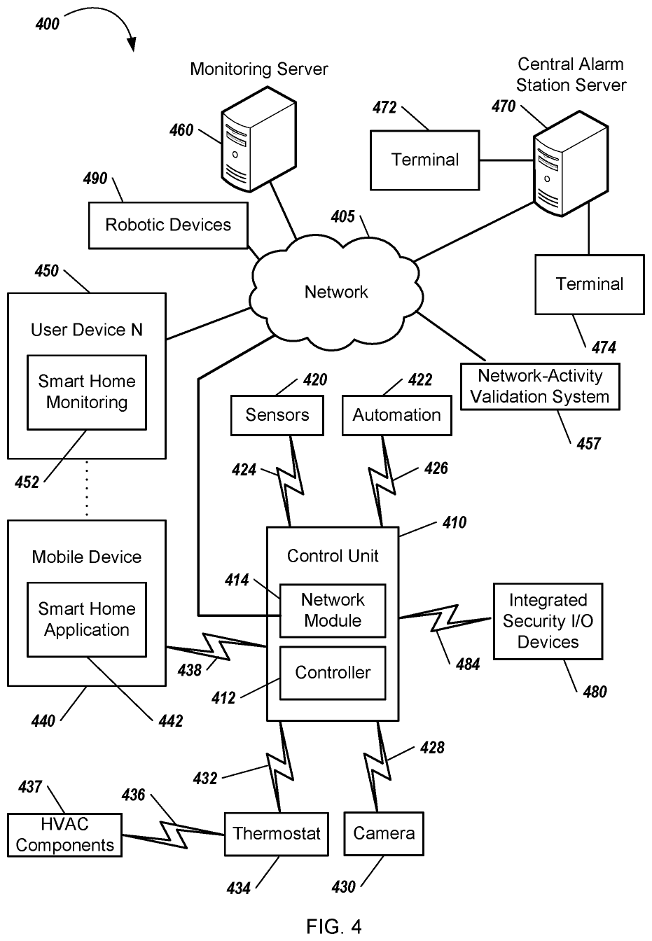

FIG. 4 is a diagram illustrating an example of a home monitoring system 400. The home monitoring system 400 includes a network 405, a control unit 410, one or more user devices 440 and 450, a monitoring server 460, and a central alarm station server 470. In some examples, the network 405 facilitates communications between the control unit 410, the one or more user devices 440 and 450, the monitoring server 460, and the central alarm station server 470.

The network 405 is configured to enable exchange of electronic communications between devices connected to the network 405. For example, the network 405 may be configured to enable exchange of electronic communications between the control unit 410, the one or more user devices 440 and 450, the monitoring server 460, and the central alarm station server 470. The network 405 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 405 may include multiple networks or subnetworks, each of which may include, for example, a wired or wireless data pathway. The network 405 may include a circuit-switched network, a packet-switched data network, or any other network able to carry electronic communications (e.g., data or voice communications). For example, the network 405 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 405 may include one or more networks that include wireless data channels and wireless voice channels. The network 405 may be a wireless network, a broadband network, or a combination of networks including a wireless network and a broadband network.

The control unit 410 includes a controller 412 and a network module 414. The controller 412 is configured to control a control unit monitoring system (e.g., a control unit system) that includes the control unit 410. In some examples, the controller 412 may include a processor or other control circuitry configured to execute instructions of a program that controls operation of a control unit system. In these examples, the controller 412 may be configured to receive input from sensors, flow meters, or other devices included in the control unit system and control operations of devices included in the household (e.g., speakers, lights, doors, etc.). For example, the controller 412 may be configured to control operation of the network module 414 included in the control unit 410.

The network module 414 is a communication device configured to exchange communications over the network 405. The network module 414 may be a wireless communication module configured to exchange wireless communications over the network 405. For example, the network module 414 may be a wireless communication device configured to exchange communications over a wireless data channel and a wireless voice channel. In this example, the network module 414 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 414 also may be a wired communication module configured to exchange communications over the network 405 using a wired connection. For instance, the network module 414 may be a modem, a network interface card, or another type of network interface device. The network module 414 may be an Ethernet network card configured to enable the control unit 410 to communicate over a local area network and/or the Internet. The network module 414 also may be a voice band modem configured to enable the alarm panel to communicate over the telephone lines of Plain Old Telephone Systems (POTS).

The control unit system that includes the control unit 410 includes one or more sensors. For example, the monitoring system 400 may include multiple sensors 420. The sensors 420 may include a lock sensor, a contact sensor, a motion sensor, or any other type of sensor included in a control unit system. The sensors 420 also may include an environmental sensor, such as a temperature sensor, a water sensor, a rain sensor, a wind sensor, a light sensor, a smoke detector, a carbon monoxide detector, an air quality sensor, etc. The sensors 420 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the home. The health monitoring sensor can collect various health data, including pulse, heart-rate, respiration rate, sugar or glucose level, bodily temperature, or motion data. The sensors 420 can also include a radio-frequency identification (RFID) sensor that identifies a particular article that includes a pre-assigned RFID tag.

The control unit 410 communicates with the home automation controls 422 and a camera 430 to perform monitoring. The home automation controls 422 are connected to one or more devices that enable automation of actions in the home. For instance, the home automation controls 422 may be connected to one or more lighting systems and may be configured to control operation of the one or more lighting systems. Also, the home automation controls 422 may be connected to one or more electronic locks at the home and may be configured to control operation of the one or more electronic locks (e.g., control Z-Wave locks using wireless communications in the Z-Wave protocol). Further, the home automation controls 422 may be connected to one or more appliances at the home and may be configured to control operation of the one or more appliances. The home automation controls 422 may include multiple modules that are each specific to the type of device being controlled in an automated manner. The home automation controls 422 may control the one or more devices based on commands received from the control unit 410. For instance, the home automation controls 422 may cause a lighting system to illuminate an area to provide a better image of the area when captured by a camera 430.

The camera 430 may be a video/photographic camera or other type of optical sensing device configured to capture images. For instance, the camera 430 may be configured to capture images of an area within a building or home monitored by the control unit 410. The camera 430 may be configured to capture single, static images of the area or video images of the area in which multiple images of the area are captured at a relatively high frequency (e.g., thirty images per second) or both. The camera 430 may be controlled based on commands received from the control unit 410.

The camera 430 may be triggered by several different types of techniques. For instance, a Passive Infra-Red (PIR) motion sensor may be built into the camera 430 and used to trigger the camera 430 to capture one or more images when motion is detected. The camera 430 also may include a microwave motion sensor built into the camera and used to trigger the camera 430 to capture one or more images when motion is detected. The camera 430 may have a “normally open” or “normally closed” digital input that can trigger capture of one or more images when external sensors (e.g., the sensors 420, PIR, door/window, etc.) detect motion or other events. In some implementations, the camera 430 receives a command to capture an image when external devices detect motion or another potential alarm event. The camera 430 may receive the command from the controller 412 or directly from one of the sensors 420.

In some examples, the camera 430 triggers integrated or external illuminators (e.g., Infra-Red, Z-wave controlled “white” lights, lights controlled by the home automation controls 422, etc.) to improve image quality when the scene is dark. An integrated or separate light sensor may be used to determine if illumination is desired and may result in increased image quality.

The camera 430 may be programmed with any combination of time/day schedules, system “arming state”, or other variables to determine whether images should be captured or not when triggers occur. The camera 430 may enter a low-power mode when not capturing images. In this case, the camera 430 may wake periodically to check for inbound messages from the controller 412. The camera 430 may be powered by internal, replaceable batteries, e.g., if located remotely from the control unit 410. The camera 430 may employ a small solar cell to recharge the battery when light is available. The camera 430 may be powered by the controller's 412 power supply if the camera 430 is co-located with the controller 412.

In some implementations, the camera 430 communicates directly with the monitoring server 460 over the Internet. In these implementations, image data captured by the camera 430 does not pass through the control unit 410 and the camera 430 receives commands related to operation from the monitoring server 460.

The system 400 also includes thermostat 434 to perform dynamic environmental control at the home. The thermostat 434 is configured to monitor temperature and/or energy consumption of an HVAC system associated with the thermostat 434, and is further configured to provide control of environmental (e.g., temperature) settings. In some implementations, the thermostat 434 can additionally or alternatively receive data relating to activity at a home and/or environmental data at a home, e.g., at various locations indoors and outdoors at the home. The thermostat 434 can directly measure energy consumption of the HVAC system associated with the thermostat, or can estimate energy consumption of the HVAC system associated with the thermostat 434, for example, based on detected usage of one or more components of the HVAC system associated with the thermostat 434. The thermostat 434 can communicate temperature and/or energy monitoring information to or from the control unit 410 and can control the environmental (e.g., temperature) settings based on commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In addition, the control unit 410 can be a gateway device that communicates with the dynamically programmable thermostat 434. In some implementations, the thermostat 434 is controlled via one or more home automation controls 422.

A module 437 is connected to one or more components of an HVAC system associated with a home, and is configured to control operation of the one or more components of the HVAC system. In some implementations, the module 437 is also configured to monitor energy consumption of the HVAC system components, for example, by directly measuring the energy consumption of the HVAC system components or by estimating the energy usage of the one or more HVAC system components based on detecting usage of components of the HVAC system. The module 437 can communicate energy monitoring information and the state of the HVAC system components to the thermostat 434 and can control the one or more components of the HVAC system based on commands received from the thermostat 434.

The system 400 includes dynamic user-interface configuration system 457. The dynamic user-interface configuration system 457 can be computing devices (e.g., a computer, microcontroller, FPGA, ASIC, or other device capable of electronic computation) capable of receiving data related to the dynamic user-interface configuration system and communicating electronically with the monitoring system control unit 410.

In some examples, the system 400 further includes one or more robotic devices 490. The robotic devices 490 may be any type of robots that are capable of moving and taking actions that assist in home monitoring. For example, the robotic devices 490 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and also roll along the ground, walls, or ceiling) and land vehicle type devices (e.g., automated cars that drive around a home). In some cases, the robotic devices 490 may be robotic devices 490 that are intended for other purposes and merely associated with the system 400 for use in appropriate circumstances. For instance, a robotic vacuum cleaner device may be associated with the monitoring system 400 as one of the robotic devices 490 and may be controlled to take action responsive to monitoring system events.

In some examples, the robotic devices 490 automatically navigate within a home. In these examples, the robotic devices 490 include sensors and control processors that guide movement of the robotic devices 490 within the home. For instance, the robotic devices 490 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 490 may include control processors that process output from the various sensors and control the robotic devices 490 to move along a path that reaches the desired destination and avoids obstacles. In this regard, the control processors detect walls or other obstacles in the home and guide movement of the robotic devices 490 in a manner that avoids the walls and other obstacles.

In addition, the robotic devices 490 may store data that describes attributes of the home. For instance, the robotic devices 490 may store a floorplan and/or a three-dimensional model of the home that enables the robotic devices 490 to navigate the home. During initial configuration, the robotic devices 490 may receive the data describing attributes of the home, determine a frame of reference to the data (e.g., a home or reference location in the home), and navigate the home based on the frame of reference and the data describing attributes of the home. Further, initial configuration of the robotic devices 490 also may include learning of one or more navigation patterns in which a user provides input to control the robotic devices 490 to perform a specific navigation action (e.g., fly to an upstairs bedroom and spin around while capturing video and then return to a home charging base). In this regard, the robotic devices 490 may learn and store the navigation patterns such that the robotic devices 490 may automatically repeat the specific navigation actions upon a later request.

In some examples, the robotic devices 490 may include data capture and recording devices. In these examples, the robotic devices 490 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 490 to take and store a biometric sample that can be used to identify the person (e.g., a biometric sample with DNA that can be used for DNA testing).

In some implementations, the robotic devices 490 may include output devices. In these implementations, the robotic devices 490 may include one or more displays, one or more speakers, and/or any type of output devices that allow the robotic devices 490 to communicate information to a nearby user.

The robotic devices 490 also may include a communication module that enables the robotic devices 490 to communicate with the control unit 410, each other, and/or other devices. The communication module may be a wireless communication module that allows the robotic devices 490 to communicate wirelessly. For instance, the communication module may be a Wi-Fi module that enables the robotic devices 490 to communicate over a local wireless network at the home. The communication module further may be a 900 MHz wireless communication module that enables the robotic devices 490 to communicate directly with the control unit 410. Other types of short-range wireless communication protocols, such as Bluetooth, Bluetooth LE, Z-wave, Zigbee, etc., may be used to allow the robotic devices 490 to communicate with other devices in the home. In some implementations, the robotic devices 490 may communicate with each other or with other devices of the system 400 through the network 405.

The robotic devices 490 further may include processor and storage capabilities. The robotic devices 490 may include any suitable processing devices that enable the robotic devices 490 to operate applications and perform the actions described throughout this disclosure. In addition, the robotic devices 490 may include solid-state electronic storage that enables the robotic devices 490 to store applications, configuration data, collected sensor data, and/or any other type of information available to the robotic devices 490.

The robotic devices 490 are associated with one or more charging stations. The charging stations may be located at predefined home base or reference locations in the home. The robotic devices 490 may be configured to navigate to the charging stations after completion of tasks needed to be performed for the home monitoring system 400. For instance, after completion of a monitoring operation or upon instruction by the control unit 410, the robotic devices 490 may be configured to automatically fly to and land on one of the charging stations. In this regard, the robotic devices 490 may automatically maintain a fully charged battery in a state in which the robotic devices 490 are ready for use by the home monitoring system 400.

The charging stations may be contact based charging stations and/or wireless charging stations. For contact based charging stations, the robotic devices 490 may have readily accessible points of contact that the robotic devices 490 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 490 may charge through a wireless exchange of power. In these cases, the robotic devices 490 need only locate themselves closely enough to the wireless charging stations for the wireless exchange of power to occur. In this regard, the positioning needed to land at a predefined home base or reference location in the home may be less precise than with a contact based charging station. Based on the robotic devices 490 landing at a wireless charging station, the wireless charging station outputs a wireless signal that the robotic devices 490 receive and convert to a power signal that charges a battery maintained on the robotic devices 490.

In some implementations, each of the robotic devices 490 has a corresponding and assigned charging station such that the number of robotic devices 490 equals the number of charging stations. In these implementations, the robotic devices 490 always navigate to the specific charging station assigned to that robotic device. For instance, a first robotic device may always use a first charging station and a second robotic device may always use a second charging station.

In some examples, the robotic devices 490 may share charging stations. For instance, the robotic devices 490 may use one or more community charging stations that are capable of charging multiple robotic devices 490. The community charging station may be configured to charge multiple robotic devices 490 in parallel. The community charging station may be configured to charge multiple robotic devices 490 in serial such that the multiple robotic devices 490 take turns charging and, when fully charged, return to a predefined home base or reference location in the home that is not associated with a charger. The number of community charging stations may be less than the number of robotic devices 490.

Also, the charging stations may not be assigned to specific robotic devices 490 and may be capable of charging any of the robotic devices 490. In this regard, the robotic devices 490 may use any suitable, unoccupied charging station when not in use. For instance, when one of the robotic devices 490 has completed an operation or is in need of battery charge, the control unit 410 references a stored table of the occupancy status of each charging station and instructs the robotic device to navigate to the nearest charging station that is unoccupied.

The system 400 further includes one or more integrated security devices 480. The one or more integrated security devices may include any type of device used to provide alerts based on received sensor data. For instance, the one or more control units 410 may provide one or more alerts to the one or more integrated security input/output devices 480. Additionally, the one or more control units 410 may receive sensor data from the sensors 420 and determine whether to provide an alert to the one or more integrated security input/output devices 480.

The sensors 420, the home automation controls 422, the camera 430, the thermostat 434, and the integrated security devices 480 may communicate with the controller 412 over communication links 424, 426, 428, 432, 438, and 484. The communication links 424, 426, 428, 432, 438, and 484 may be a wired or wireless data pathway configured to transmit signals from the sensors 420, the home automation controls 422, the camera 430, the thermostat 434, and the integrated security devices 480 to the controller 412. The sensors 420, the home automation controls 422, the camera 430, the thermostat 434, and the integrated security devices 480 may continuously transmit sensed values to the controller 412, periodically transmit sensed values to the controller 412, or transmit sensed values to the controller 412 in response to a change in a sensed value.

The communication links 424, 426, 428, 432, 438, and 484 may include a local network. The sensors 420, the home automation controls 422, the camera 430, the thermostat 434, and the integrated security devices 480, and the controller 412 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 460 is an electronic device configured to provide monitoring services by exchanging electronic communications with the control unit 410, the one or more user devices 440 and 450, and the central alarm station server 470 over the network 405. For example, the monitoring server 460 may be configured to monitor events (e.g., alarm events) generated by the control unit 410. In this example, the monitoring server 460 may exchange electronic communications with the network module 414 included in the control unit 410 to receive information regarding events (e.g., alerts) detected by the control unit 410. The monitoring server 460 also may receive information regarding events (e.g., alerts) from the one or more user devices 440 and 450.

In some examples, the monitoring server 460 may route alert data received from the network module 414 or the one or more user devices 440 and 450 to the central alarm station server 470. For example, the monitoring server 460 may transmit the alert data to the central alarm station server 470 over the network 405.

The monitoring server 460 may store sensor and image data received from the monitoring system 400 and perform analysis of sensor and image data received from the monitoring system 400. Based on the analysis, the monitoring server 460 may communicate with and control aspects of the control unit 410 or the one or more user devices 440 and 450.

The monitoring server 460 may provide various monitoring services to the system 400. For example, the monitoring server 460 may analyze the sensor, image, and other data to determine an activity pattern of a resident of the home monitored by the system 400. In some implementations, the monitoring server 460 may analyze the data for alarm conditions or may determine and perform actions at the home by issuing commands to one or more of the controls 422, possibly through the control unit 410.

The central alarm station server 470 is an electronic device configured to provide alarm monitoring service by exchanging communications with the control unit 410, the one or more mobile devices 440 and 450, and the monitoring server 460 over the network 405. For example, the central alarm station server 470 may be configured to monitor alerting events generated by the control unit 410. In this example, the central alarm station server 470 may exchange communications with the network module 414 included in the control unit 410 to receive information regarding alerting events detected by the control unit 410. The central alarm station server 470 also may receive information regarding alerting events from the one or more mobile devices 440 and 450 and/or the monitoring server 460.

The central alarm station server 470 is connected to multiple terminals 472 and 474. The terminals 472 and 474 may be used by operators to process alerting events. For example, the central alarm station server 470 may route alerting data to the terminals 472 and 474 to enable an operator to process the alerting data. The terminals 472 and 474 may include general-purpose computers (e.g., desktop personal computers, workstations, or laptop computers) that are configured to receive alerting data from a server in the central alarm station server 470 and render a display of information based on the alerting data. For instance, the controller 412 may control the network module 414 to transmit, to the central alarm station server 470, alerting data indicating that a sensor 420 detected motion from a motion sensor via the sensors 420. The central alarm station server 470 may receive the alerting data and route the alerting data to the terminal 472 for processing by an operator associated with the terminal 472. The terminal 472 may render a display to the operator that includes information associated with the alerting event (e.g., the lock sensor data, the motion sensor data, the contact sensor data, etc.) and the operator may handle the alerting event based on the displayed information.

In some implementations, the terminals 472 and 474 may be mobile devices or devices designed for a specific function. Although FIG. 4 illustrates two terminals for brevity, actual implementations may include more (and, perhaps, many more) terminals.

The one or more authorized user devices 440 and 450 are devices that host and display user interfaces. For instance, the user device 440 is a mobile device that hosts or runs one or more native applications (e.g., the smart home application 442). The user device 440 may be a cellular phone or a non-cellular locally networked device with a display. The user device 440 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 440 may perform functions unrelated to the monitoring system, such as placing personal telephone calls, playing music, playing video, displaying pictures, browsing the Internet, maintaining an electronic calendar, etc.

The user device 440 includes a smart home application 442. The smart home application 442 refers to a software/firmware program running on the corresponding mobile device that enables the user interface and features described throughout. The user device 440 may load or install the smart home application 442 based on data received over a network or data received from local media. The smart home application 442 runs on mobile devices platforms, such as iPhone, iPod touch, Blackberry, Google Android, Windows Mobile, etc. The smart home application 442 enables the user device 440 to receive and process image and sensor data from the monitoring system.

The user device 450 may be a general-purpose computer (e.g., a desktop personal computer, a workstation, or a laptop computer) that is configured to communicate with the monitoring server 460 and/or the control unit 410 over the network 405. The user device 450 may be configured to display a smart home user interface 452 that is generated by the user device 450 or generated by the monitoring server 460. For example, the user device 450 may be configured to display a user interface (e.g., a web page) provided by the monitoring server 460 that enables a user to perceive images captured by the camera 430 and/or reports related to the monitoring system. Although FIG. 4 illustrates two user devices for brevity, actual implementations may include more (and, perhaps, many more) or fewer user devices.

In some implementations, the one or more user devices 440 and 450 communicate with and receive monitoring system data from the control unit 410 using the communication link 438. For instance, the one or more user devices 440 and 450 may communicate with the control unit 410 using various local wireless protocols such as Wi-Fi, Bluetooth, Z-wave, Zigbee, HomePlug (ethernet over power line), or wired protocols such as Ethernet and USB, to connect the one or more user devices 440 and 450 to local security and automation equipment. The one or more user devices 440 and 450 may connect locally to the monitoring system and its sensors and other devices. The local connection may improve the speed of status and control communications because communicating through the network 405 with a remote server (e.g., the monitoring server 460) may be significantly slower.

Although the one or more user devices 440 and 450 are shown as communicating with the control unit 410, the one or more user devices 440 and 450 may communicate directly with the sensors and other devices controlled by the control unit 410. In some implementations, the one or more user devices 440 and 450 replace the control unit 410 and perform the functions of the control unit 410 for local monitoring and long range/offsite communication.

In other implementations, the one or more user devices 440 and 450 receive monitoring system data captured by the control unit 410 through the network 405. The one or more user devices 440, 450 may receive the data from the control unit 410 through the network 405 or the monitoring server 460 may relay data received from the control unit 410 to the one or more user devices 440 and 450 through the network 405. In this regard, the monitoring server 460 may facilitate communication between the one or more user devices 440 and 450 and the monitoring system.

In some implementations, the one or more user devices 440 and 450 may be configured to switch whether the one or more user devices 440 and 450 communicate with the control unit 410 directly (e.g., through link 438) or through the monitoring server 460 (e.g., through network 405) based on a location of the one or more user devices 440 and 450. For instance, when the one or more user devices 440 and 450 are located close to the control unit 410 and in range to communicate directly with the control unit 410, the one or more user devices 440 and 450 use direct communication. When the one or more user devices 440 and 450 are located far from the control unit 410 and not in range to communicate directly with the control unit 410, the one or more user devices 440 and 450 use communication through the monitoring server 460.

Although the one or more user devices 440 and 450 are shown as being connected to the network 405, in some implementations, the one or more user devices 440 and 450 are not connected to the network 405. In these implementations, the one or more user devices 440 and 450 communicate directly with one or more of the monitoring system components and no network (e.g., Internet) connection or reliance on remote servers is needed.

In some implementations, the one or more user devices 440 and 450 are used in conjunction with only local sensors and/or local devices in a house. In these implementations, the system 400 includes the one or more user devices 440 and 450, the sensors 420, the home automation controls 422, the camera 430, the robotic devices 490, and the dynamic user-interface configuration system 457. The one or more user devices 440 and 450 receive data directly from the sensors 420, the home automation controls 422, the camera 430, the robotic devices 490, and the dynamic user-interface configuration system 457 and sends data directly to the sensors 420, the home automation controls 422, the camera 430, the robotic devices 490, and the dynamic user-interface configuration system 457. The one or more user devices 440, 450 provide the appropriate interfaces/processing to provide visual surveillance and reporting.

In other implementations, the system 400 further includes network 405 and the sensors 420, the home automation controls 422, the camera 430, the thermostat 434, the robotic devices 490, and the dynamic user-interface configuration system 457 are configured to communicate sensor and image data to the one or more user devices 440 and 450 over network 405 (e.g., the Internet, cellular network, etc.). In yet another implementation, the sensors 420, the home automation controls 422, the camera 430, the thermostat 434, the robotic devices 490, and the dynamic user-interface configuration system 457 (or a component, such as a bridge/router) are intelligent enough to change the communication pathway from a direct local pathway when the one or more user devices 440 and 450 are in close physical proximity to the sensors 420, the home automation controls 422, the camera 430, the thermostat 434, the robotic devices 490, and the dynamic user-interface configuration system 457 to a pathway over network 405 when the one or more user devices 440 and 450 are farther from the sensors 420, the home automation controls 422, the camera 430, the thermostat 434, the robotic devices 490, and the dynamic user-interface configuration system 457. In some examples, the system leverages GPS information from the one or more user devices 440 and 450 to determine whether the one or more user devices 440 and 450 are close enough to the sensors 420, the home automation controls 422, the camera 430, the thermostat 434, the robotic devices 490, and the dynamic user-interface configuration system 457 to use the direct local pathway or whether the one or more user devices 440 and 450 are far enough from the sensors 420, the home automation controls 422, the camera 430, the thermostat 434, the robotic devices 490, and the dynamic user-interface configuration system 457 that the pathway over network 405 is required. In other examples, the system leverages status communications (e.g., pinging) between the one or more user devices 440 and 450 and the sensors 420, the home automation controls 422, the camera 430, the thermostat 434, the robotic devices 490, and the dynamic user-interface configuration system 457 to determine whether communication using the direct local pathway is possible. If communication using the direct local pathway is possible, the one or more user devices 440 and 450 communicate with the sensors 420, the home automation controls 422, the camera 430, the thermostat 434, the robotic devices 490, and the dynamic user-interface configuration system 457 using the direct local pathway. If communication using the direct local pathway is not possible, the one or more user devices 440 and 450 communicate with the sensors 420, the home automation controls 422, the camera 430, the thermostat 434, the robotic devices 490, and the dynamic user-interface configuration system 457 using the pathway over network 405.

In some implementations, the system 400 provides end users with access to images captured by the camera 430 to aid in decision-making. The system 400 may transmit the images captured by the camera 430 over a wireless WAN network to the user devices 440 and 450. Because transmission over a wireless WAN network may be relatively expensive, the system 400 can use several techniques to reduce costs while providing access to significant levels of useful visual information (e.g., compressing data, down-sampling data, sending data only over inexpensive LAN connections, or other techniques).

In some implementations, a state of the monitoring system 400 and other events sensed by the monitoring system 400 may be used to enable/disable video/image recording devices (e.g., the camera 430). In these implementations, the camera 430 may be set to capture images on a periodic basis when the alarm system is armed in an “away” state, but set not to capture images when the alarm system is armed in a “home” state or disarmed. In addition, the camera 430 may be triggered to begin capturing images when the alarm system detects an event, such as an alarm event, a door-opening event for a door that leads to an area within a field of view of the camera 430, or motion in the area within the field of view of the camera 430. In other implementations, the camera 430 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A computer-implemented method comprising:
detecting sensors that are installed at a physical location associated with a user account;
determining data for the user account associated with a user device;
selecting, based on the sensors that are installed at the physical location and the data for the user account associated with the user device, a graphical user interface component to show in a user interface on a display of the user device from a set of graphical user interface components; and
providing the graphical user interface component to show in the user interface on the display of the user device.

2. The method of claim 0, wherein:
determining the data for the user account associated with the user device comprises determining a physical location of the user device; and
selecting the graphical user interface component comprises selecting, based on the sensors that are installed at the physical location and the data for the user account, the graphical user interface component to show on the display of the user device from a set of graphical user interface components in response to determining the physical location of the user device.

3. The method of claim 0, wherein:
determining the data for the user account associated with the user device comprises determining that the user device is physically located near the physical location at which the sensors are installed; and
selecting the graphical user interface component comprises selecting, based on the sensors that are installed at the physical location and the data for the user account, the graphical user interface component to show on the display of the user device from a set of graphical user interface components in response to determining that the user device is physically located near the physical location.

4. The method of claim 3, wherein determining that the user device is physically located near the physical location at which the sensors are installed comprises receiving, from one of the sensors, sensor data that indicates that the user device is physically located near the physical location at which the sensors are installed.

5. The method of claim 3, comprising:
determining a particular sensor from the sensors that is physically closest to the user device; and
selecting the graphical user interface component comprises selecting, based on the particular sensor that is physically closest to the user device and the data for the user account, the graphical user interface component to show on the display of the user device from a set of graphical user interface components in response to determining the physical location of the user device.

6. The method of claim 3, comprising:
receiving near field communication data that indicates that at least one of the sensors created a near field communication connection with the user device, wherein determining that the user device is physically located near the physical location at which the sensors are installed comprises determining, using the near field communication data, that the user device is physically located near the physical location at which the sensors are installed.

7. The method of claim 6, wherein receiving the near field communication data comprises receiving the near field communication data that indicates that at least one of the sensors created a WiFi connection with the user device.

8. The method of claim 0, wherein the physical location comprises at least a portion of a property.

9. The method of claim 8, wherein the at least the portion of the property comprises a room on the property.

10. The method of claim 8, wherein the at least the portion of the property comprises a building on the property.

11. The method of claim 0, wherein:
determining the data for the user account associated with the user device comprises determining historical use data that indicates input received by the user interface for the user account; and
selecting the graphical user interface component comprises selecting, based on data for the sensors that are installed at the physical location and the historical use data that indicates the input received by the user interface for the user account, the graphical user interface component to show on the display of the user device from a set of graphical user interface components.

12. The method of claim 11, wherein the historical use data comprises data for two or more other user accounts different from the user account associated with the user device.

13. The method of claim 12, wherein:
the account for the user device is associated with a user interface type from a group of multiple, different user interface types each of which is associated with a subset of the accounts from the two or more other user accounts;
the historical data comprises data for the user accounts in the two or more other user accounts that are associated with the user interface type; and
selecting the graphical user interface component comprises selecting, based on data for the sensors that are installed at the physical location and the historical use data for the user accounts that are associated with the user interface type, the graphical user interface component to show on the display of the user device from a set of graphical user interface components.

14. The method of claim 0, wherein:
determining the data for the user account associated with the user device comprises determining, using the data for the user account, demographic data for people who live in a house with a user of the user device; and
selecting the graphical user interface component comprises selecting, based on data for the sensors that are installed at the physical location and the demographic data for the people who live in the house with the user of the user device, the graphical user interface component to show on the display of the user device from a set of graphical user interface components.

15. The method of claim 0, comprising:
determining, for a sensor from the detected sensors, user interface configuration parameters a) defined by a third party, and b) that indicate a weight for at least one graphical user interface component from the set of graphical user interface components, wherein selecting the graphical user interface component comprises selecting the graphical user interface component to show on the display of the user device from a set of graphical user interface components using data for the sensors that are installed at the physical location, the data for the user account, and the user interface configuration parameters that indicate the weight for at least one graphical user interface component from the set of graphical user interface components.

16. The method of claim 15, wherein the third party comprises one of a manufacturer the sensor, an installer of the sensor, and a home security provider that offers services based on data from the sensor.

17. The method of claim 0, comprising:
detecting second sensors a) that are installed at the physical location associated with the user account, and b) are different sensors from the sensors;
selecting, from the set of graphical user interface components and based on the second sensors that are installed at the physical location and the data for the user account associated with the user device, a second graphical user interface component to show in the user interface on the display of the user device, the second graphical user interface component being a different user interface component from the graphical user interface component; and
providing the second graphical component to show in the user interface on the display of the user device.

18. The method of claim 17, comprising:
detecting third sensors a) that are installed at another physical location associated with the user account, and b) are different sensors from the sensors and the second sensors;
selecting, from the set of graphical user interface components and based on the third sensors that are installed at the physical location and the data for the user account associated with the user device, the second graphical user interface component to show in the user interface on the display of the user device, wherein the second graphical user interface component comprises a default graphical user interface component for the user account; and
providing the second graphical component to show in the user interface on the display of the user device.

19. The method of claim 18, wherein the physical location and the other physical location are the same physical location.

20. A system comprising:
one or more computers and one or more storage devices storing instructions that are operable, when executed by the one or more computers, to cause the one or more computers to perform operations comprising:
detecting sensors that are installed at a physical location associated with a user account;
determining data for the user account associated with a user device;
selecting, based on the sensors that are installed at the physical location and the data for the user account associated with the user device, a graphical user interface component to show in a user interface on a display of the user device from a set of graphical user interface components; and
providing the graphical user interface component to show in the user interface on the display of the user device.

21. A non-transitory computer-readable medium storing software comprising instructions executable by one or more computers which, upon such execution, cause the one or more computers to perform operations comprising:
detecting sensors that are installed at a physical location associated with a user account;
determining data for the user account associated with a user device;
selecting, based on the sensors that are installed at the physical location and the data for the user account associated with the user device, a graphical user interface component to show in a user interface on a display of the user device from a set of graphical user interface components; and
providing the graphical user interface component to show in the user interface on the display of the user device.
